(19) United States
(12) Patent Application Publication
(10) Pub. No.: US 2010/0047731 A1
(43) Pub. Date: Feb. 25, 2010

(54) DENTAL FURNACE, AND METHOD FOR CONTROLLING THE POSITION OF AN ASSOCIATED CLOSING PLATE

(75) Inventor: Kurt Zubler, Neu-Ulm (DE)

Correspondence Address: Myers Andras Sherman LLP, 19900 MacArthur Blvd., Suite 1150, Irvine, CA, 92612, US

(73) Assignee: ZUBLER GERATEBAU GMBH, Ulm-Jungingen (DE)

(21) Appl. No.: 12/373,522

(22) PCT Filed: Jul. 13, 2007
(86) PCT No.: PCT/EP2007/006223

§ 371 Date: Oct. 6, 2009

(30) Foreign Application Priority Data
Jul. 13, 2006 (DE) 10 2006032 655.5

(51) Int. Cl. F27B 17/02; F27D 19/00; F27B 5/18

(52) U.S. Cl. 432/45; 432/36; 432/53; 432/1

(57) ABSTRACT

The invention relates to a dental furnace (1) comprising a hood-shaped combustion chamber (3) with a heating element (12) that is placed therein and an opening (13), and a closing plate (4) which is arranged so as to be movable relative to the combustion chamber (3) and is used for accommodating a material (5) that is to be baked, particularly a tooth replacement object. Said dental furnace (1) further comprises a sensor (31) for determining the combustion chamber temperature. In order to optimize the drying time and closing time, a measuring instrument (7b) is provided for recording the actual value of the position of the closing plate relative to the combustion chamber (3) while an arithmetic unit (51) is provided for determining the deviation from the comparison between the determined actual value and a defined required value so as to derive a control variable for triggering the relative position between the closing plate (4) and the combustion chamber (5). Also disclosed is a method for controlling the position of a closing plate (4) on the dental furnace (1) in order to minimize the process time.

The invention relates to a dental furnace in accordance with the preamble of claim 1 as well as a method for controlling the position of a closing plate at a dental furnace according to claim 10.

Artificial dentures of ceramic are often manufactured on frames in layer technology or as tooth caps. The frame is mainly made from metal alloys, on which the various layers of ceramic material are applied, dried and then fired. For example, for drying and/or firing multi-function dental furnaces are used, which process programmes defined for the coated layer. For instance, the programmes cover a drying, a firing and a cooling phase. The different phases are all processed in the same firing chamber, wherein their durations are at best tuned to the thickness of the coated layer. For instance, the drying phase requires a predetermined drying time. The employed apparatuses consist at least of a firing chamber and a closure plate, which are movable relative to each other. The firing chamber is maintained at 400-600° C. (standby temperature), in dependence of the selected material and firing procedure, and radiates the generated heat in the opened state to the closure plate and/or the material positioned on it. For a drying phase (closing time) a temperature of approx. 120-160° C. is used as optimum. The furnace will be gradually closed, usually within a period of 6 min. Experience shows that a sufficient drying process and slow heating of the material is achieved after this time. When the furnace is completely closed, the firing chamber will be evacuated and the actual heating phase is started.

Although various furnaces are equipped with functions, which are to make the firing process as smooth as possible and convenient, opaquers and ceramics are often strongly damaged on pre-drying. For example, known furnaces are provided with a lifting system (lift) for closing the firing chamber by lowering it onto the closing plate (firing plate) and or by driving the closing plate towards the firing chamber. Almost all ceramic furnaces control the pre-drying phase, as the lift travels a defined distance (insertion into the firing chamber) in a certain time (closing time). When the dental object moves into the opened firing chamber of 400-600° C. with uniform movement during this closing time, the object, which homogeneously dries at a temperature between 120 and 160° C., is outside of the necessary temperature range most of the closing time. At the start of the closing operation with a completely opened firing chamber the object lies in a too cold region, while the temperature drastically increases in the upward direction. The liquid portions of the surface of such inadequately pre-dried objects evaporate under pressure at high temperature. In more favourable controls of some furnaces a particular position of the firing plate is set for drying process, at which drying occurs in the suitable temperature range, before the lift continues the closing process. However, in such ceramics furnaces, the target position for this firing plate position is associated with the adjusted standby temperature. As long as this temperature is not reached, no start of the closing process can take place.

Furthermore, apparatuses with pivoting firing chambers or with swinging firing plates are available. The variety of the present apparatuses causes various disadvantages for the drying process. Thus, a non-uniform course of the drying phase results from such designs. From this again it results that a comparison of the drying parameters between the different apparatuses is only partially possible. Thus, it is almost impossible to derive clear and standardized instructions for use, in order to reach reproducible results with each dental material employed.

The mentioned drying faults may cause material stress, which can lead to fissures and bubble formation and thus quality losses of the surfaces of each layer. Further, bonding of the ceramic layers to each other might be poor. In addition, the process includes waiting periods, as the drying or closing of the furnace only begins when the standby temperature of the firing chamber is reached.

Thus, the object of the current invention is to achieve a uniform drying process of a material, in particular artificial dentures, with optimum temperature and to shorten the drying and closing time to a minimum.

This is achieved a dental furnace according to claim 1 and by a method for controlling the position of a closing plate at a dental furnace in accordance with claim 10. Other favourable embodiments of the invention are subject matter of the dependent claims.

The dental furnace according to the invention has a hood-shaped firing chamber, in whose interior at least a heating element is arranged. The opening of the firing chamber is directed to a closure plate, which is relatively movable to the firing chamber. The closure plate (firing plate) serves as the receptacle of dental material, in particular an artificial dentures object. For instance, the artificial dentures object can be a complete object made of ceramics or a frame made of metal, on which further layers of dental materials are burned or sintered in the manufacturing process. The dental furnace is characterised by a sensor for determining the firing chamber temperature. Further, the dental furnace has a measuring device to detect the actual value of the closing plate position relative to the firing chamber as well as a computing unit for determining the offset by comparison of the detected actual value with a defined desired value and to derive a drive variable from it.

Preferably, the dental furnace is provided with an electric, hydraulic and/or pneumatic drive. With a stationary mounted firing chamber the closure plate is moved into the firing chamber up to its closure by this drive (lift). Beyond that it is however also possible that with embodiments having a stationary firing plate that the firing chamber is moved towards the firing plate. In another embodiment of the dental furnace both closing plate as well as firing chamber are movable mounted and can thus moved towards each other or away from each other, respectively.

According to the invention, the actual position value of the closing plate in relation to the firing chamber is detected by a measuring device. In a preferred embodiment of the dental furnace the actual value is derived from the gap distance between the closure plate (firing plate) and the opening of the firing chamber.

To achieve a reproducible drying result of the various materials or artificial dentures objects, it is preferred to define a specific desired value of the closing plate position for each one of the materials or layer materials depending on the firing chamber temperature. The target value can be further dependent on the temperature value at the firing plate and/or at the material and/or on the ambient temperature.

The desired value thus results for example from a function, depending on the optimum drying parameters for the respective material, on the temperature of the firing chamber, on the temperature at the closing plate (firing plate) and/or at the material as well as the ambient temperature as computation parameters. The specific values for the closing plate position are stored in the memory unit, which the computer unit can access during the entire drying phase, in order to derive from the comparison of target/actual values the correcting variable.

Thus, a preferable embodiment of the dental furnace additionally has a detector for the ambient temperature beside the sensor for the temperature in the firing chamber. Such a sensor is particularly recommendable, if the dental technology furnace is for example operated at various locations with strongly different temperatures, or within laboratory areas and/or locations of the furnace, at which high temperature variations occur, e.g. due to different sun exposure. As the drying process starts with an incompletely closed firing chamber, the dental material is affected by the ambient temperature, as well. Thus, additional detection of this parameter is in the interest of an optimum control of the drying phase.

In another favourable embodiment of the dental furnace according to the invention determining of temperature values is made at the firing plate and/or at the material by a measuring system, arranged thereon. The detection of these temperature values is particularly favourable in dual respect. To the one, the temperature at the firing plate and/or material can be used as parameters in the calculation of the desired value of the firing plate position; on the other hand this parameter, detected in the development phase of new materials or apparatuses, can be used as basis for manuals or operating instructions.

The measuring system can be made of one or several sensors or detectors. These are arranged either in the vicinity of the closing plate and/or the material or are directly mounted thereon. It is also possible to arrange the sensor(-)s on, at or in the supports (firing bases), used for the dental materials. A preferred position of the measuring system corresponds to the layer structure of the material. In a preferable embodiment, the material has a multi-layer structure,

It is positive, when the dental furnace has a memory unit, as all or selected parts of the detected values can be stored in such a unit. First, this storage proves to be favourable for the above definition of the drying parameters for the development of new materials and apparatuses; on the other hand, such storage permits complete evaluation of past drying operations. This again is helpful for error tracing and, for example, also in tracing working steps in a certification procedure.

In addition, the current invention provides a method for controlling the position of a closure plate at a dental furnace. This method includes the subsequent steps:

First, a determination of a current firing chamber temperature is made. Additionally or in the alternative, a temperature value can be detected at the closing plate and/or at the material to be dried. In another step the actual value of the closing plate position relative to the firing chamber is received. The computing unit compares the actual value with a desired value of the closing plate position depending on the firing chamber temperature and/or the temperature value at the closing plate and/or at the material and derives a correcting variable. This manipulation variable is passed on to the control to balance the deviation and the position of the closing plate and/or the firing chamber by operation of an electric, a pneumatic and/or a hydraulic drive correspondingly adjusted. The determination of the above values and the derivation of the manipulation variables are continuously made during the entire drying phase. The desired values for the respective dental materials are stored in the memory unit, which the computer unit accesses during the target/actual value comparison. For the drying phase, which is processed with constant temperature by controlling the closing plate position as described above, a duration of approx. 3 minutes is sufficient, in order to bring that material subsequently in 1-2 minutes gradually and/or slow into the hot firing chamber. Before closing, another step of interrogation of the current firing chamber temperature is made and from it the assignment of the appropriate closing time results from the programme. In addition, a continuous target/actual value comparison prevents complete closing or insertion into the firing chamber, as long as the temperature within the firing chamber lies above the permissible standby temperature.

It is particularly favourable when the gap distance between the closure plate and the opening of the firing chamber directed thereto is detected as actual value by a corresponding measuring device.

In order to reach particularly reproducible results, it is favourable to make a determination of the ambient temperature since the desired value for the closing plate position in a preferable embodiment of the invention process depends on the firing chamber temperature and in a smaller extent also on the ambient temperature. Further, the target value can also include the respective temperature value at the closing plate and/or at the material additionally.

Other advantages, features and features of the invention will result from the subsequent description of preferred, but not limiting embodiments of the invention on the basis the schematic drawing. It shows:

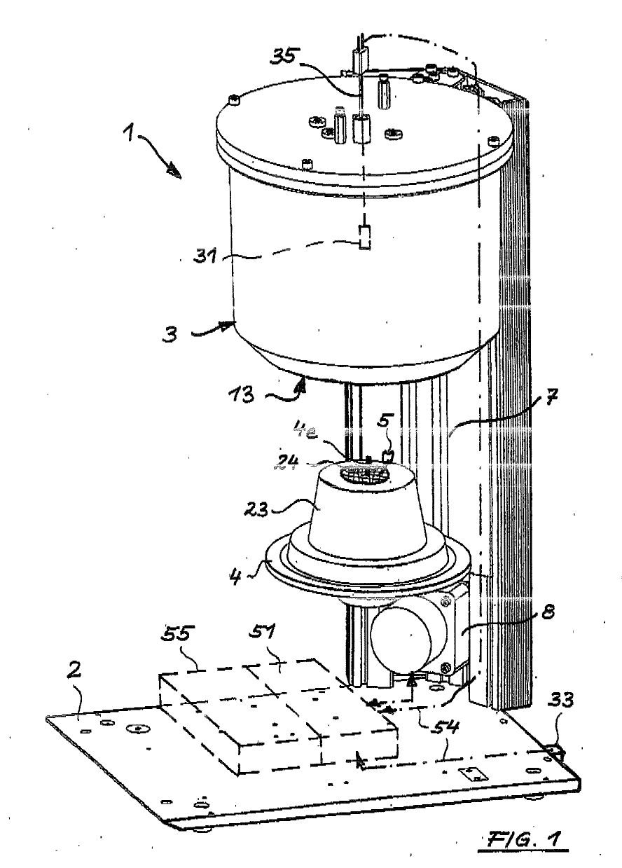

FIG. 1 a preferred embodiment of a dental furnace according to invention;

FIG. 2 a sectional view of a closing plate; and

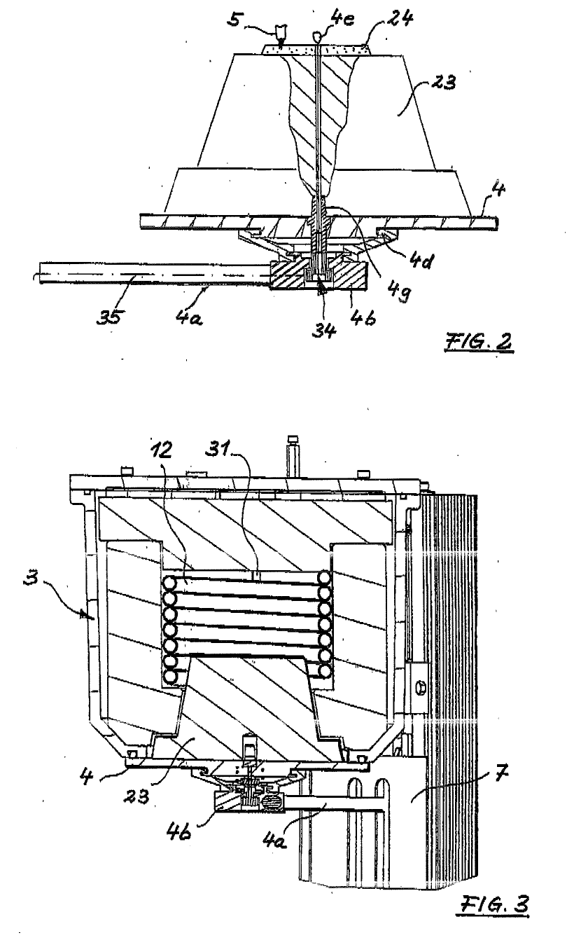

FIG. 3 the closing plate in accordance with FIG. 2 in closed position.

FIG. 1 shows an embodiment of a dental furnace 1 according to the invention, in which a firing chamber 3 and a closure plate 4 are arranged movable towards each other. Here, the closure of the firing chamber 3 is accomplished by pressing the closing plate 4 against the firing chamber 3 (cf. FIG. 3). In the embodiment of FIG. 1, the firing chamber 3 and the closing plate 4 are attached at a guide 7. The movement in type of a lift is made by an electric drive 8, which is housed at a furnace basis 2 and propels a toothed belt in the guide 7, in order to drive the closing plate 4 in the height. The closure plate 4 is mounted at a support 4b (cf. FIG. 2), which is connected to the guide 7 by a connector 4a. Alternatively, the firing chamber 3 can also be moved along the guide 7.

Inside the firing chamber 3 heating elements 12 (cf. FIG. 3) are disposed. In the embodiment there are heating coils, which are arranged in the firing chamber 3 at its circumference. A sensor 31 for determining the temperature of the firing chamber 3 is centrally located in the firing chamber 3 and connected to a memory unit 55 via a connection cable 35. The values detected in the firing chamber 3 are continuously read from the memory unit 55 and processed by a computing unit 51. In the embodiment of FIG. 1 the computing unit 51 is arranged at the furnace basis 2. The computing unit 51 has a keyboard for input of alphanumeric data. Additionally, a monitor can be provided for indicating among other things the currently detected values, the parameters of the selected material, the selected programme etc. The computing unit 51 can also have card slots for additional storage mediums or for linking several dental furnaces 1 or for connection with a server (not shown). Data lines 54 between the computing unit 51, the memory unit 55, and the sensor 31 are provided for rapid transmission of the respective values, as well as to a position measuring system provided in the guide 7 for detecting the respective height position of the closing plate 3. Such position measuring systems are known, for example from the machine tool industry as distance measuring systems and therefore not described.

In the embodiment of FIG. 1, another sensor 33 is shown as independent element to detect the ambient temperature, being connected via a data line 54 directly with the computing unit 51. The sensor 33 is remotely mounted at the dental furnace 1, in order to avoid an interference of the measurement results by the heat radiation from the firing chamber 3.

A firing base 23 made of insulating material and a material carrier 24 for the dental material 5 are centrally disposed on the closure plate 4. In the embodiment of the FIG. 1 a sensor of a measuring system 34 is passed through the closing plate 4 and the firing base 23, in order to continuously detect measurement data of the temperature, transmitted over the connection cable 35 directly to the computing unit 51. The measuring point 4e of the measuring system 34 is preferably at the position of the material 5, arranged above the firing base 23.

By the previously mentioned position measuring system in the guide 7 the actual value of the position of the closure plate 4 relative the firing chamber 3 is continuously detected. Thus, the gap between the opening 13 (here downwardly orientated) of the firing chamber 3 and the surface of the firing base 23, directed to the firing chamber 3 is measured.

In the embodiment of FIG. 1 a recordable data carrier (e.g. a memory card) is provided in the memory unit 55 or at the computing unit 51 for storing the parameters of the respective material and various types of furnaces as well as the additional writing of the detected values.

FIG. 2 shows a sectional view of the closing plate 4, which is attached on a support 4b. For this purpose recesses 4d on the underside of the closing plate 4 are engaged with a corresponding receptacle of the support 4b. In the central location on the closing plate 4 there's disposed a guide pin 4g for the positioning of the firing base 23. On the firing base 23 a material carrier 24 with the material 5 is placed. Inside the guide pin 4g, as well as in the insulating material of the firing base 23 the measuring system 34 is provided together with its leads (to the terminal of the connection cable 35). The measuring system 34 projects over the surface of the firing base 23. The support 4b is arranged at the connector 4a, which is coupled with the guide 7 of the dental furnace 1 (not shown in FIG. 2).

In the embodiment of FIG. 2 temperature measurement is made at a single measuring point 4e in the region of the material 5 over the firing base 23. Beyond that it is however also conceivable to define additional measuring points at other locations of the firing base 23 or in the firing chamber 3 in order to reach more exact measurement results. In the course of the drying process of the dental material 5, disposed on the firing base 23, a position change of the closure plate 4 relative to the firing chamber 3 is made as soon as necessary. For drying, first the material 5 is placed on the firing base 23 by way of the material carrier 24. Then the closing plate 4 is moved towards the firing chamber 3 being in the heating process. The sensor 31 continuously measures the temperature in the firing chamber 3 and the measuring system 34 senses the temperature above the firing base 23 close to the material 5 and if necessary, the sensor 33 detects the ambient temperature. In addition, the gap between the opening 13 of the firing chamber 3 and the closing plate 4 is detected by the measuring system in the guide 7 and passed as actual value to the computing unit 51. Comparing these temperature values with the desired values for the position of the closing plate 4, stored in the memory unit 55 for corresponding temperature values, results in a manipulation variable. The desired value is a parameter defined in preliminary tests for each material and each type of furnace and indicates in each case the gap distance between firing chamber 3 and closing plate 4, with which the material 5 is within the optimum temperature range during the drying phase.

The manipulation variable is passed on to a controller, which regulates the distance between closing plate 4 and firing chamber 3 by the drive 8, i.e. these two components are moved closer or more distanced to each other. By the continuous determination of this manipulation variable and the change of the distance between closing plate 4 and firing chamber 3, material 5 can be introduced already in the pre-heating or cooling phase of the firing chamber 3 of the dental furnace 1 and the drying process can start independently. Thus, a significant saving of time results in the entire manufacturing process of artificial dentures objects, as the furnace does not require a fixed starting temperature. Thus, the waiting period for cooling-down is avoided, in particular with subsequent firing processes. Further, energy for heating of the dental furnace 1 can be used more efficiently. By the automatic correction of the closing time, a drying process can even be completed within the cooling time of the firing chamber. Due to the continuous temperature monitoring, as mentioned above, the drying process is always in the optimum temperature range. By the invention process also the closing occurs at a uniform temperature rise until the moment of the complete closure (cf. illustration in FIG. 3), although the temperature in the firing chamber 3 during the closing process might still be above the permissible standby temperature. This affects the quality of the prepared artificial dentures objects in a positive way, since fissures and other surface impairments are prevented by avoiding rapid or non-uniform heating stress. Further, the optimum drying conditions can lower the drying time and closing time to only 4-5 min compared to the usual 6 min. The permanent supervision and storage of the parameters mentioned permits improved reproduction of the drying results.

### REFERENCE LIST

1=dental furnace
2=furnace basis
3=firing chamber
4=closing plate
4a=connector
4b=support
4d=recess
4e=measuring point
4gguide pin
5=dental material
7=guide
8=drive
12=heating element
13=opening
23=firing socket
24=material carrier
31=sensor
33=detector
34=measuring system
35=connection cable
51=computing unit
54=data line
55=memory unit

1-15. (canceled)

16. Dental furnace with a hood-shaped firing chamber having a heating element disposed therein, and an opening as well as a closing plate for receiving a dental material, in particular an artificial dentures object, the closing plate being movable relative to the firing chamber, wherein the dental furnace has a sensor to determine the firing chamber temperature,
characterized by
a measuring system to detect the actual value of the closing plate position relative to the firing chamber and a computing unit to determine the difference from the comparison of the detected actual value with a defined desired value to derive a variable for controlling the relative position between closing plate and firing chamber.

17. Dental furnace according to claim 16, characterized in that an electric, hydraulic and/or pneumatic drive is provided to move the closure plate and/or the firing chamber.

18. Dental furnace according to claim 17, characterized in that the actual value is derived from the gap distance between that closing plate and the opening of the firing chamber.

19. Dental furnace according to claim 17, characterized in that an additional sensor is provided to detect the ambient temperature.

20. Dental furnace according to claim 16, characterized in that the actual value is derived from the gap distance between that closing plate and the opening of the firing chamber.

21. Dental furnace according to claim 20, characterized in that an additional sensor is provided to detect the ambient temperature.

22. Dental furnace according to claim 16, characterized in that an additional sensor is provided to detect the ambient temperature.

23. Dental furnace according to claim 16, characterized in that a specific desired value of the closing plate position is defined for each dental material in dependence of the firing chamber temperature and/or the temperature values at the closing plate and/or at the material and/or the ambient temperature.

24. Dental furnace according to claim 16, characterized in that at least one measuring system is arranged at the closing plate to determine temperature values at the closure plate and/or at the material.

25. Dental furnace according to claim 24, characterized in that the measuring system is aligned with the corresponding layer structure of the dental material.

26. Dental furnace according to claim 16, characterized in that that the dental material is multi-layered.

27. Dental furnace according to claim 16, characterized in that a memory unit is provided for storing the detected values.

28. Method for controlling the position of a closing plate at a dental furnace, comprising the steps:
detecting a current firing chamber temperature and/or a temperature value at the closing plate and/or at the dental material,
detecting an actual value of the closing plate position relative to the firing chamber,
comparing the actual value of the closing plate position with a target value of the closing plate position depending on one of the firing chamber temperature and/or the temperature value at the closing plate and/or at the dental material,
deriving a variable from the difference between actual and target value, and
transmitting the variable to a drive to balance the difference.

29. Method according to claim 28, characterized in that the gap distance between the closing plate and an opening of the firing chamber directed to the closure plate is detected as actual value.

30. Method according to one of claim 29, characterized in that an additional determination of the ambient temperature is made.

31. Method according to claim 30, characterized in that the target value for the closing plate position is dependent on the temperature of the firing chamber and/or the temperature value at the closing plate and/or at the dental material and the ambient temperature.

32. Method according to claim 29, characterized in that the target value for the closing plate position is dependent on the temperature of the firing chamber and/or the temperature value at the closing plate and/or at the dental material and the ambient temperature.

33. Method according to claim 28, characterized in that a additional determination of the ambient temperature is made.

34. Method according to claim 33, characterized in that the target value for the closing plate position is dependent on the temperature of the firing chamber and/or the temperature value at the closing plate and/or at the dental material and the ambient temperature.

35. Method according to claim 28, characterized in that the target value for the closing plate position is dependent on the temperature of the firing chamber and/or the temperature value at the closing plate and/or at the dental material and the ambient temperature.

36. Method according to claim 28, characterized in that the closing time is computed from the remaining cooling time of the dental furnace to a target temperature.

37. Method according to claim 28, characterized in that closure of the firing chamber is completed only when the target temperature is reached.
